(19) United States
(12) Patent Application Publication
(10) Pub. No.: US 2025/0086595 A1
(43) Pub. Date: Mar. 13, 2025

(54) APPARATUS AND METHOD FOR GENERATING A TIMETABLE

(71) Applicant: Actriv Healthcare Inc., Tacoma, WA (US)

(72) Inventor: Allan Njoroge, Tacoma, WA (US)

(73) Assignee: Actriv Healthcare Inc., Tacoma, WA (US)

(21) Appl. No.: 18/367,601

(22) Filed: Sep. 13, 2023

(51) Int. Cl. G06Q 10/109

(52) U.S. Cl. CPC G06Q 10/109

(57) ABSTRACT

An apparatus and method for generating a timetable is disclosed. The apparatus includes a memory communicatively connected to at least a processor, wherein the memory contains instructions configuring the at least a processor to obtain first timetable data that includes empty table information that includes empty time information and at least an empty table constraint, obtain provider data that includes provider information and provider time information, determine at least a general provider as a function of the provider time information and the empty time information, determine a selected provider as a function of the provider information and the at least an empty table constraint and generate a second timetable as a function of the selected provider, wherein generating the second timetable further includes receiving a confirm feature input from a provider device and generating the second timetable as a function of the confirm feature input and the selected provider.

### FIELD OF THE INVENTION

The present invention generally relates to the field of a timetable. In particular, the present invention is directed to apparatus and method for generating a timetable.

### BACKGROUND

Timetables are widely used in various domains. Traditionally, timetables have been manually created by individuals, which can be time-consuming, prone to errors, and challenging to optimize. Existing technologies have limited flexibility and are insufficient to address these challenges. Therefore, there is a need for an improved system and method that can efficiently generate timetables to maximize efficiency.

### SUMMARY OF THE DISCLOSURE

In an aspect, an apparatus for generating a timetable is disclosed. The apparatus includes at least a processor and a memory communicatively connected to the at least a processor, wherein the memory contains instructions configuring the at least a processor to obtain first timetable data, wherein the first timetable data includes empty table information, wherein the empty table information includes empty time information and at least an empty table constraint, obtain provider data, wherein the provider data includes provider information and provider time information, determine at least a general provider as a function of the provider time information of the provider data and the empty time information of the empty table information of the first timetable data, determine a selected provider among the at least a general provider as a function of the provider information of the provider data and the at least an empty table constraint of the empty table information of the first timetable data and generate a second timetable as a function of the selected provider, wherein generating the second timetable further includes receiving a confirm feature input from a provider device and generating the second timetable as a function of the confirm feature input and the selected provider.

In another aspect, a method for generating a timetable is disclosed. The method includes obtaining, using at least a processor, first timetable data, wherein the first timetable data includes an empty table information, wherein the empty table information includes empty time information and at least an empty table constraint, obtaining, using the at least a processor, provider data, wherein the provider data includes provider information and provider time information, determining, using the at least a processor, at least a general provider as a function of the provider time information and the empty time information, determining, using the at least a processor, a selected provider among the at least a general provider as a function of the provider information and the at least an empty table constraint and generating, using the at least a processor, a second timetable as a function of the selected provider, wherein generating the second timetable further includes receiving a confirm feature input from a provider device and generating the second timetable as a function of the confirm feature input and the selected provider.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a block diagram of exemplary apparatus for generating a timetable;

FIG. 2 illustrates a block diagram of exemplary embodiment of a machine learning module;

FIG. 3 illustrates a diagram of an exemplary nodal network;

FIG. 4 illustrates a block diagram of an exemplary node;

FIG. 5 illustrates a block diagram of a timetable database;

FIG. 6 is an illustration of an exemplary graphical user interface of a user device;

FIG. 7 illustrates a flow diagram of an exemplary method for generating a timetable; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatuses and methods for generating a timetable is disclosed. The apparatus includes at least a processor and a memory communicatively connected to the at least a processor, wherein the memory contains instructions configuring the at least a processor to obtain first timetable data, wherein the first timetable data includes empty table information, wherein the empty table information includes empty time information and at least an empty table constraint, obtain provider data, wherein the provider data includes provider information and provider time information, determine at least a general provider as a function of the provider time information of the provider data and the empty time information of the empty table information of the first timetable data, determine a selected provider among the at least a general provider as a function of the provider information of the provider data and the at least an empty table constraint of the empty table information of the first timetable data and generate a second timetable as a function of the selected provider, wherein generating the second timetable further includes receiving a confirm feature input from a provider device and generating the second timetable as a function of the confirm feature input and the selected provider. Exemplary embodiments illustrating aspects of the present disclosure are described below in the context of several specific examples.

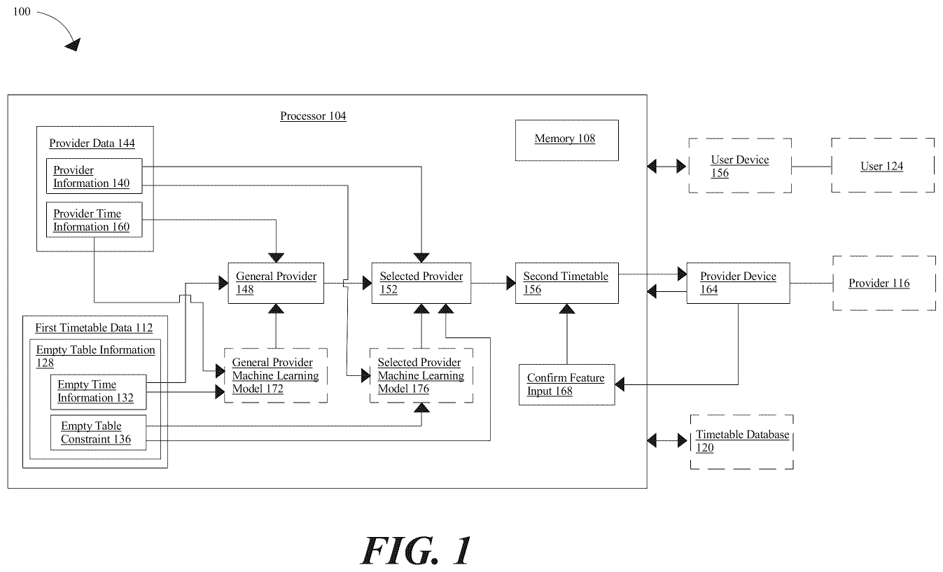

Referring now to FIG. 1, an exemplary embodiment of an apparatus 100 for generating a timetable is illustrated. Apparatus 100 includes at least a processor 104. Processor 104 may include, without limitation, any processor described in this disclosure. Processor 104 may be included in a computing device. Processor 104 may include any computing device as described in this disclosure, including without limitation a microcontroller, microprocessor, digital signal processor (DSP) and/or system on a chip (SoC) as described in this disclosure. Processor 104 may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented, as a non-limiting example, using a “shared nothing” architecture.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 includes a memory 108 communicatively connected to processor 104. For the purposes of this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory 108 contains instructions configuring processor 104 to obtain first timetable data 112. For the purposes of this disclosure, “first timetable data” is data related to a user and the user's timetable. For the purposes of this disclosure, a “timetable” is a schedule that outlines the specific timing and sequence of events, activities, or tasks. For the purposes of this disclosure, a “first timetable” is a schedule that outlines the specific timing and sequence of events, activities, or tasks that are conducted of a user, facilitated through the utilization of a service provided by a provider. In some embodiments, first timetable may include a plurality of time slots. For the purposes of this disclosure, a “time slot” is a specific interval of time within a timetable. In some embodiments, time slot may include a fixed date, time, duration, and the like. As a non-limiting example, time slot may include Jun. 5, 2023, Monday with a duration of 2 hours from 9 am to 11 am. As another non-limiting example, time slot may include time slot may include Jun. 5, 2023, Monday with a duration of 1 hours from 11 am to 12 pm. In some embodiments, each time slot may include slot information. As a non-limiting example, time slot of Jun. 5, 2023, Monday with a duration of 2 hours from 9 am to 11 am may include slot information of a name of provider 116 that delivers service for the time slot, type of services the provider 116 will deliver in the time slot, or the like. In some embodiments, first timetable data 112 may be stored in a timetable database 120. In some embodiments, first timetable data 112 may be retrieved from timetable database 120. Timetable database 120 disclosed herein is further described below.

With continued reference to FIG. 1, for the purposes of this disclosure, a “user” is an individual, group, company, or any entity that uses a service of a provider. As a non-limiting example, user 124 may include an employer, healthcare facility, restaurant, hotel, office building, retail store, manufacturing facility, business owner, event organizer, government agency, educational institution, nonprofit organization, corporation, or the like. For example, and without limitation, healthcare facility may include hospital, clinic, medical center, nursing home, rehabilitation center, pharmacy, or the like. Persons skilled in the art, upon reviewing the entirety of this disclosure, may appreciate various users 124 that may use or need a provider 116's service.

With continued reference to FIG. 1, for the purposes of this disclosure, a “provider” is an individual, group, company, or any entity who provides a service to a user. As a non-limiting example, provider 116 may include an employee, information technology (IT) service provider, telecommunication service provider, healthcare service provider, financial service provider, transportation service provider, legal service provider, educational service provider, hospitality service provider, consulting service provider, cleaning service provider, personal care provider, hone repair service provider, advertising service provider, event planning service provider, catering service provider, fitness service provider, pet care service provider, photography and videography service provider, translation service provider, real estate service provider, occupational service provider, manufacturing service provider, customer service provider, and any service provider thereof. For example, and without limitation, healthcare service provider may include a doctor, nurse, pharmacist, physical therapist, caregiver, emergency service technician (EMT), or the like. In some embodiments, provider 116 may be licensed in certain areas of service or jurisdictions. In some embodiments, provider 116 may include a plurality of providers 116. As a non-limiting example, the plurality of providers 116 may include providers 116 that provides the same services. As another non-limiting example, the plurality of providers 116 may include providers 116 that providers different services.

With continued reference to FIG. 1, for the purposes of this disclosure, a “service” is an act or performance provided to a user by a provider. As a non-limiting example, service may include legal services, healthcare services, financial services, consulting services, transportation services, educational services, entertainment services, travel services, cleaning services, maintenance services, fitness services, pet care services, real estate services, occupational services, manufacturing services, customer services, and any services thereof. In some embodiments, each of the service may include sub-services that may be more specific than general services. As a non-limiting example, the healthcare services may include diagnostic service, rehabilitative service, medicative service, supportive service, or the like. The example above merely shows exemplary sub-services for healthcare services, and various sub-services for other services may be appreciated by persons skilled in the art upon reviewing the entirety of this disclosure.

With continued reference to FIG. 1, first timetable data 112 includes empty table information 128. For the purposes of this disclosure, “empty table information” is information related to an empty table of a user's timetable that needs a provider to deliver a service for the user. For the purposes of this disclosure, an “empty table” is a time slot of a timetable that does not include a provider assigned to deliver a service, awaiting the designation of a provider. In some embodiment, first timetable may include a plurality of empty tables. In some embodiments, empty table information 128 may include an empty table task. For the purposes of this disclosure, an “empty table task” is a description of actions and responsibilities involved in working within an empty table. As a non-limiting example, when user includes a healthcare facility, empty table task of first timetable (the healthcare facility's timetable) may include patient consultation, treatment planning, medical procedures, surgical interventions, monitoring, follow-up, health education, rehabilitation service, mental health service, care coordination, or the like. In some embodiments, empty table information 128 may include user information. For the purposes of this disclosure, “user information” is information related to a user who is looking for a provider for an empty table of the user's timetable. As a non-limiting example, user information may include a location, total number of employees, reviews of user 124, or the like. In some embodiments, empty table information 128 may include information related to any individual, group or entity that is related to empty table or user 124. As a non-limiting example, empty table information 128 may include information related to coworker, sponsor, related organization, or the like. Examples above are merely examples and persons skilled in the art, upon reviewing the entirety of this disclosure, may appreciate various empty table tasks that can be used in apparatus 100.

With continued reference to FIG. 1, empty table information 128 includes empty time information 132. For the purposes of this disclosure, “empty time information” is information related to time of an empty table of a user's timetable that is awaiting the designation of a provider. In an embodiment, empty table information 128 may include specific time, duration, date, day, week, month, year, or the like. As a non-limiting example, empty time information 132 may include 8 am to 10 am, 9 am to 5 pm, 10 pm to 4 am, 11 am to 12 am, 1:30 pm to 4:30 pm, 7:30 pm to 8 pm, 11:45 am to 2:30 pm, anytime, or the like. As another non-limiting example, empty time information 132 may include duration of 10 minutes, 15 minutes, 30 minutes, 45 minutes, 90 minutes, 1 hour, 2 hours, 5 hours, 8 hours, 15 hours, or the like. As another non-limiting example, empty time information 132 may include Monday, Tuesday, Wednesday, Thursday, Friday, Saturday, Sunday or any combination of days. For example, and without limitation, empty time information 132 may include Monday and Tuesday, Monday, Wednesday and Friday, Saturday and Sunday (such as weekends), Tuesday and Thursday, Monday to Saturday, Monday to Sunday (such as all days or any days), or the like. As another non-limiting example, empty time information 132 may include January, February, March, April, May, June, July, August, September, October, November, December, or any combination of months. For example, and without limitation, empty time information 132 may include January to December (all months or any months), January and May, March to July, October to December, or the like. As another non-limiting example, empty time information 132 may include 2023, 2024, 2025, or the like. As another non-limiting example, empty time information 132 may include May 8^{th} of 2023 July 11^{th} of 2023 December 12^{th} to 20^{th} of 2023 April 2^{nd} to August 1^{st} of 2024, or the like. In some embodiments, empty time information 132 may include any combination of empty time information 132. In a non-limiting example, empty time information 132 may include 4 hours from 6 am to 10 am every Tuesday and Thursday in July of 2023. In another non-limiting example, empty time information 132 may include 2 hours from 10 am to 12 pm every Monday, Wednesday and Thursday from May to June of 2023 and 5 hours from 3 pm to 8 pm every Tuesday and Friday from May to June of 2023. In another non-limiting example, empty time information 132 may include 8:30 am to 9:15 am on May 25^{th} of 2023 and 5 pm to 7 pm on May 28^{th} of 2023. In another non-limiting example, empty time information 132 may include anytime during every day in September. Examples of empty time information 132 above are merely examples and persons skilled in the art, upon reviewing the entirety of this disclosure, may appreciate various empty time information 132 that can be used in apparatus 100.

With continued reference to FIG. 1, empty table information 128 includes at least an empty table constraint 136. For the purposes of this disclosure, an “empty table constraint” is a qualification that a provider should possess in order to provide a service within an empty table of a first timetable (a user's timetable). As a non-limiting example, empty table constraint 136 may include a specific skill, skill level, education history, service experience, age, gender, or the like. As another non-limiting example, empty table constraint 136 may include a specific gender of male, female, non-binary, does not want to answer, or the like. As another non-limiting example, empty table constraint 136 may include specific service experience of less than 1 year, between 1-2 years, 2-3 years, 3-5 years, 6-10 years, more than 10 years, or the like. As another non-limiting example, empty table constraint 136 may include specific education history of associate, bachelor, master, doctoral, postdoctoral, Juris Doctor (J.D.) for law, Doctor of Medicine (M.D.) for medicine, Doctor of Pharmacy (Pharm.D.) for pharmacy, and Doctor of Dental Surgery (D.D.S.), Doctor of Dental Medicine (D.M.D.) for dentistry, or the like. As another non-limiting example, empty table constraint 136 may include specific skill level of beginner, intermediate, advanced, expert, or the like. As another non-limiting example, empty table constraint 136 may include specific numerical value of a review of provider 116. For the purposes of this disclosure, a “review” is an evaluation or critique of a provider, the provider's service or user. In an embodiment, review of provider 116 may include a numerical value. As a non-limiting example, review may include 2 in a set range of 5, 4.5 in a set range of 5, 5 in a set range of 10, 7.8 in a set range of 10, or the like. In another embodiment, review of provider 116 may include a string containing a plurality of words. As a non-limiting example, review may include ‘good quality of work,’ ‘kind and meticulous,’ ‘hardworking and diligent,’ ‘always late to work and poor time management,’ ‘not professional,’ or the like. In a non-limiting example, empty table constraint 136 may include 4.4 or more in a set range of 5 for a numerical value of a review of a provider 116. In another non-limiting example, empty table constraint 136 may include 8 or more in a set range of 10 for a numerical value of a review of a provider 116. As another non-limiting example, empty table constraint 136 may include specific keyword of a review of provider 116 (constraint keyword). As used in this disclosure, a “keyword” is an element of word or syntax used to identify and/or match elements to each other. In a non-limiting example, empty table constraint 136 may include ‘good,’ ‘excellent,’ ‘great,’ ‘kind,’ ‘time management,’ ‘diligent,’ ‘hardworking,’ ‘organizational skill,’ or the like. In another non-limiting example, empty table constraint 136 may include ‘bad,’ ‘poor,’ ‘late,’ ‘not professional,’ ‘lazy,’ ‘arrogant,’ or the like. As another non-limiting example, empty table constraint 136 may include specific keyword of self-description of provider information 140 (constraint keyword). The self-description disclosed herein is further described below. For example, and without limitation, empty table constraint 136 may include ‘good,’ ‘excellent,’ ‘great,’ ‘time management,’ ‘diligent,’ ‘hardworking,’ ‘organizational skill,’ ‘attention to detail,’ ‘technology,’ ‘client-focused,’ ‘goal-focused,’ or any keywords of self-description. Examples above are merely examples and persons skilled in the art, upon reviewing the entirety of this disclosure, may appreciate various empty table constraint 136 that can be used in apparatus 100.

With continued reference to FIG. 1, in some embodiments, empty table information 128 may include a provider quantity. For the purposes of this disclosure, a “provider quantity” is a number of providers needed for an empty table of a first timetable. As a non-limiting example, provider quantity may include any numerical value. For example, and without limitation, provider quantity may include 1, 2, 3, 4, 5, 8, 10, 15, or the like.

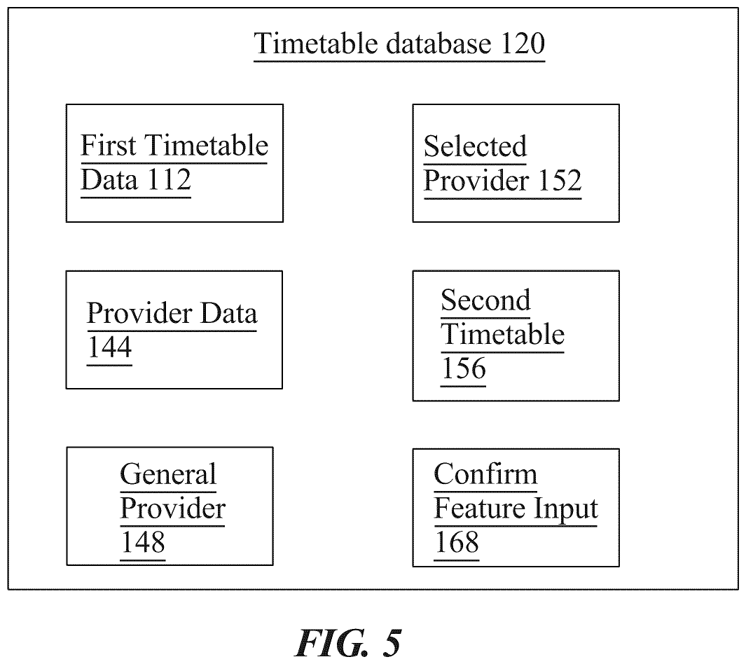

With continued reference to FIG. 1, in some embodiments, processor 104 may obtain first timetable data 112 from a timetable database 120. In some embodiments, apparatus 100 may include a timetable database 120. As used in this disclosure, “timetable database” is a data structure configured to store data associated with a timetable. As a non-limiting example, timetable database 120 may store first timetable data 112, empty table information 128, empty time information 132, empty table constraint 136, provider data 144, general provider 148, selected provider 152, second timetable 156, and the like. In one or more embodiments, timetable database 120 may include inputted or calculated information and datum related to a timetable (such as first timetable or second timetable 156). In some embodiments, a datum history may be stored in timetable database 120. As a non-limiting example, the datum history may include real-time and/or previous inputted data related to a timetable (such as first timetable or second timetable 156). For example, and without limitation, timetable database 120 may store first timetable data 112, provider data 144, general provider 148, selected provider 152, second timetable 156, and the like. In one or more embodiments, timetable database 120 may include real-time or previously determined data related to second timetable 156. As a non-limiting example, timetable database 120 may include instructions from a user, who may be an expert user, a past user in embodiments disclosed herein, or the like, where the instructions may include examples of the data related to timetable. Timetable database 120 disclosed herein is further described with respect to FIG. 5.

With continued reference to FIG. 1, in some embodiments, processor 104 may be communicatively connected with timetable database 120. For example, and without limitation, in some cases, timetable database 120 may be local to processor 104. In another example, and without limitation, timetable database 120 may be remote to processor 104 and communicative with processor 104 by way of one or more networks. The network may include, but is not limited to, a cloud network, a mesh network, and the like. By way of example, a “cloud-based” system can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure processor 104 connect directly, dynamically, and non-hierarchically to as many other computing devices as possible. A “network topology” as used in this disclosure is an arrangement of elements of a communication network. The network may use an immutable sequential listing to securely store timetable database 120. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. An immutable sequential listing may be, include and/or implement an immutable ledger, where data entries that have been posted to the immutable sequential listing cannot be altered.

With continued reference to FIG. 1, in some embodiments, timetable database 120 may include keywords. As a non-limiting example, provider 116 or user 124 may query timetable database 120 for certain information using keyword. For example, without limitation, keyword may include a “name of user” in the instance that provider 116 is looking for a specific user 124. In another non-limiting example, keyword may include a “name of provider” in the instance that user 124 is looking of a specific user 124. For example, without limitation, keyword may include “specific certification” in the instance that user 124 is looking for provider 116 with specific certification.

With continued reference to FIG. 1, in some embodiments, timetable database 120 may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, in some embodiments, processor 104 may obtain first timetable data 112 from user device 156. For the purposes of this disclosure, a “user device” is any device a user uses to input data. As a non-limiting example, user 124 may input first timetable data 112, user response, and the like. For example, and without limitation, user 124 may manually input empty table information 128, empty table task, empty time information 132, empty table constraint 136, provider quantity, time slot of first timetable, slot information, or the like. In an embodiment, user device 156 may include a personal device. For the purposes of this disclosure, a “personal device” is any device personally owned by a user. As a non-limiting example, personal device may include a laptop, tablet, mobile phone, smart watch, or things of the like. In some embodiments, user device 156 may include an interface configured to receive inputs from user 124. In some embodiments, user 124 may have a capability to process, store or transmit any information independently. In another embodiment, user device 156 may include a shared device. For the purposes of this disclosure, a “shared device” is a device that is designed for use by multiple users. In some embodiments, shared device may be used by different users 124 at different times. As a non-limiting example, shared device may include desktop computers, kiosks, smartphones, laptops, tablets, or the like. User device 156 disclosed herein is further described below.

With continued reference to FIG. 1, in some embodiments, processor 104 may obtain first timetable data 112 using a timetable application programming interface (API). As used herein, an “application programming interface” is a set of functions that allow applications to access data and interact with external software components, operating systems, or microdevices, such as another web application or computing device. In some embodiments, processor 104 may be configured to call timetable APIs for first timetable data 112. As a non-limiting example, a timetable API may include Google Calendar API, Microsoft Graph API, Apple Calendar API, Calendly API, Timely APPI, or the like.

With continued reference to FIG. 1, in some embodiments, processor 104 may obtain first timetable data 112 using a web crawler. As a non-limiting example, processor 104 may obtain user information using web crawler. In some embodiments, provider information 140 may include a resume of a provider. As another non-limiting example, processor 104 may obtain provider 116's resume, self-description, review of provider 116, or any provider information 140 thereof using web crawler. A “web crawler,” as used herein, is a program that systematically browses the internet for the purpose of Web indexing. Web crawler may be seeded with platform URLs, wherein the crawler may then visit the next related URL, retrieve the content, index the content, and/or measures the relevance of the content to the topic of interest. In some embodiments, processor 104 may generate a web crawler to scrape user information from a user 124's website, user rating (review) API, or the like. As a non-limiting example, user rating API may include GLASSDOOR, GOOGLE PLACES, or the like. In some embodiments, processor 104 may generate a web crawler to scrape provider information 140 from social media site, job-posting site, or the like. Web crawler may be seeded and/or trained with a reputable website, such as but not limited to LINKEDIN, INDEED, MONSTER, or the like, to begin the search. Web crawler may be generated by processor 104. In some embodiments, web crawler may be trained with information received from user 124 and/or provider 116 through a user interface. The user interface disclosed herein is further described in detail below. In some embodiments, web crawler may be configured to generate a web query. A web query may include search criteria received from a user. For example, user may submit a plurality of websites for the web crawler to search to record statistics from and correlate to user information, and the like. Additionally, web crawler function may be configured to search for and/or detect one or more data patterns. A “data pattern” as used in this disclosure is any repeating forms of information. In some embodiments, web crawler may be configured to determine the relevancy of a data pattern. Relevancy may be determined by a relevancy score. A relevancy score may be automatically generated by processor 104, received from a machine learning model, and/or received from user. In some embodiments, a relevancy score may include a range of numerical values that may correspond to a relevancy strength of data received from a web crawler function. As a non-limiting example, a web crawler function may search the Internet for user information, or the like.

With continued reference to FIG. 1, in some embodiments, processor 104 may be configured to classify empty table information 128 into one or more empty table groups. For the purposes of this disclosure, a “empty table group” is a set of associative empty table information. In some embodiments, each empty table group may include one empty table (empty time slot of user 124's timetable) and associated empty table information 128. As a non-limiting example, empty table group may include a first empty table, second empty table, third empty table, fourth empty table group, or the like, where each group includes one distinct empty table of first timetable and associated empty table information 128 such as empty table task, user information, empty time information 132, empty table constraint 136, provider quantity, or the like. Examples above are merely examples and persons skilled in the art, upon reviewing the entirety of this disclosure, may appreciate various empty table groups that can be used in apparatus 100. In some embodiments, empty table group may be stored in timetable database 120. In some embodiments, empty table group may be retrieved from timetable database 120.

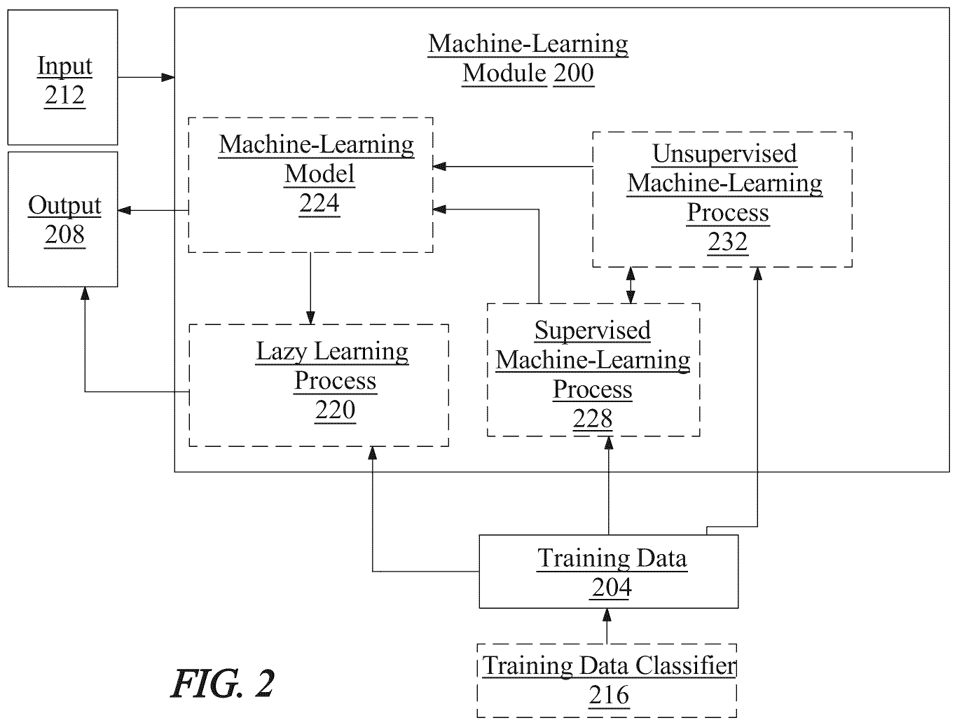

With continued reference to FIG. 1, in some embodiments, processor 104 may be configured to classify empty table information 128 of first timetable data 112 into one or more empty table groups using an empty table group classifier. For the purposes of this disclosure, a “empty table group classifier” is a machine-learning model, such as a mathematical model, neural net, or program generated by a machine learning algorithm known as a “classification algorithm,” that sorts empty table information related inputs into categories or bins of data, outputting one or more empty table groups associated therewith. The empty table group classifier disclosed herein may be consistent with a classifier disclosed with respect to FIG. 2. In some embodiments, empty table group classifier may be trained with empty table group training data correlating an empty table information set to one or more empty table groups. The training data disclosed herein is further disclosed with respect to FIG. 2. In some embodiments, empty table group training data may be stored in a timetable database 120. In some embodiments, empty table group training data may be received from one or more users, timetable database 120, external computing devices, and/or previous iterations of processing. As a non-limiting example, empty table group training data may include instructions from a user, who may be an expert user, a past user in embodiments disclosed herein, or the like, which may be stored in memory and/or stored in timetable database 120, where the instructions may include labeling of training examples.

With continued reference to FIG. 1, in some embodiment, empty table group classifier may be trained with empty table group training data correlating an empty table information set to one or more empty table groups. As a non-limiting example, empty table group training data may correlate empty table information 128 of a first empty table and empty table task, user information, empty time information 132, empty table constraint 136, provider quantity, or the like of the first empty table to a first empty table group. As another non-limiting example, empty table group training data may correlate empty table information 128 of a second empty table and empty table task, user information, empty time information 132, empty table constraint 136, provider quantity, or the like of the second empty table to a second empty table group. As another non-limiting example, empty table group training data may correlate empty table information 128 of a third empty table and empty table task, user information, empty time information 132, empty table constraint 136, provider quantity, or the like of the third empty table to a third empty table group. Examples above are merely examples and persons skilled in the art, upon reviewing the entirety of this disclosure, may appreciate various empty table group training data that can be used in apparatus 100.

With continued reference to FIG. 1, in some embodiments, processor 104 may be configured to classify empty table information 128 into one or more empty table groups using an empty table group lookup table. For the purposes of this disclosure, a “empty table group lookup table” is a lookup table that relates the empty table information to one or more empty table groups. Empty table group lookup table disclosed herein may be consistent with lookup table described below. In some embodiment, processor 104 may ‘lookup’ given empty table information 128 to find corresponding empty table groups using empty table group lookup table. As a non-limiting example, empty table group lookup table may correlate empty table information 128 of a first empty table and empty table task, user information, empty time information 132, empty table constraint 136, provider quantity, or the like of the first empty table to a first empty table group. As another non-limiting example, empty table group lookup table may correlate empty table information 128 of a second empty table and empty table task, user information, empty time information 132, empty table constraint 136, provider quantity, or the like of the second empty table to a second empty table group. As another non-limiting example, empty table group lookup table may correlate empty table information 128 of a third empty table and empty table task, user information, empty time information 132, empty table constraint 136, provider quantity, or the like of the third empty table to a third empty table group.

With continued reference to FIG. 1, in some embodiments, processor 104 may be configured to classify empty table constraint 136 of first timetable data 112 into one or more constraint groups. In some embodiments, each empty table group may include one or more constraint groups. For the purposes of this disclosure, a “constraint group” is a set of associative empty table constraints. As a non-limiting example, constraint group may include a skill, skill level, education history, service experience, age, gender, review group, or the like. In some embodiments, constraint group may include a subgroup. For the purposes of this disclosure, a “subgroup” is a subset of a set of associative data. As a non-limiting example, skill level group may include subgroup of a beginner, intermediate, advanced, expert group, or the like. As another non-limiting example, education history group may include subgroup of an associate, bachelor, master, doctoral, postdoctoral, Juris Doctor (J.D.) for law, Doctor of Medicine (M.D.) for medicine, Doctor of Pharmacy (Pharm.D.) for pharmacy, and Doctor of Dental Surgery (D.D.S.), Doctor of Dental Medicine (D.M.D.) for dentistry group, or the like. As another non-limiting example, service experience group may include subgroup of a less than 1 year, between 1-2 years, 2-3 years, 3-5 years, 6-10 years, more than 10 years group, or the like. As another non-limiting example, review group may include subgroup of a numerical value group such as but not limited to 1-2 review group, 2-3 review group, 3-4 review group, 4-5 review group, 5-6 review group, 6-7 review group, or the like. As another non-limiting example, review group may include subgroup of a keyword group such as but not limited to a ‘good,’ ‘excellent,’ ‘great,’ ‘kind,’ ‘time management,’ ‘diligent,’ ‘hardworking,’ ‘organizational skill,’ ‘bad,’ ‘poor,’ ‘late,’ ‘not professional,’ ‘lazy,’ ‘arrogant’ group, or the like. As another non-limiting example, age group may include subgroup of a male, female, non-binary, does not want to answer group, or the like. Examples above are merely examples and persons skilled in the art, upon reviewing the entirety of this disclosure, may appreciate various constraint groups that can be used in apparatus 100. In some embodiments, constraint group may be stored in timetable database 120. In some embodiments, constraint group may be retrieved from timetable database 120.

With continued reference to FIG. 1, in some embodiments, processor 104 may be configured to classify empty table constraint 136 of first timetable data 112 into one or more constraint groups using a constraint group classifier. For the purposes of this disclosure, a “constraint group classifier” is a machine-learning model, such as a mathematical model, neural net, or program generated by a machine learning algorithm known as a “classification algorithm,” that sorts empty table constraint related inputs into categories or bins of data, outputting one or more constraint groups associated therewith. The constraint group classifier disclosed herein may be consistent with a classifier disclosed with respect to FIG. 2. In some embodiments, constraint group classifier may be trained with constraint group training data correlating a plurality of empty table constraints 136 to one or more constraint groups. The training data disclosed herein is further disclosed with respect to FIG. 2. In some embodiments, constraint group training data may be stored in a timetable database 120. In some embodiments, constraint group training data may be received from one or more users, timetable database 120, external computing devices, and/or previous iterations of processing. As a non-limiting example, constraint group training data may include instructions from a user, who may be an expert user, a past user in embodiments disclosed herein, or the like, which may be stored in memory and/or stored in timetable database 120, where the instructions may include labeling of training examples.

With continued reference to FIG. 1, in some embodiment, constraint group classifier may be trained with constraint group training data correlating a plurality of empty table constraints 136 to one or more constraint groups. As a non-limiting example, constraint group training data may correlate empty table constraint 136 of a specific gender of female to a female group of gender group of constraint group. As another non-limiting example, constraint group training data may correlate empty table constraint 136 of a specific skill level of intermediate to an intermediate group of skill level group of constraint group. As another non-limiting example, constraint group training data may correlate empty table constraint 136 of a specific education history of postdoctoral to a postdoctoral group of education history group of constraint group. As another non-limiting example, constraint group training data may correlate empty table constraint 136 of a specific service experience of 4 years or more to a 3-5 years group of service experience group of constraint group. As another non-limiting example, constraint group training data may correlate empty table constraint 136 of a specific numerical value of review of provider 116 of 4.4 or more to a 4-5 review group of review group of constraint group. As another non-limiting example, constraint group training data may correlate empty table constraint 136 of a specific keyword of review of provider 116 of ‘hardworking’ to a ‘hardworking’ group of review group of constraint group. Examples above are merely examples and persons skilled in the art, upon reviewing the entirety of this disclosure, may appreciate various constraint group training data that can be used in apparatus 100.

With continued reference to FIG. 1, processor 104 may be configured to generate a classifier (such as but not limited to constraint group classifier, empty table group classifier or provider group classifier) using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P (A/B)=P (B/A)P(A)÷P(B), where P (A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Processor 104 may then calculate a likelihood table by calculating probabilities of different data entries and classification labels. Processor 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 1, processor 104 may be configured to generate classifier (such as but not limited to constraint group classifier, empty table group classifier or provider group classifier) using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database 200, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With continued reference to FIG. 1, in some embodiments, processor 104 may be configured to classify empty table constraint 136 into one or more constraint groups using a constraint group lookup table. For the purposes of this disclosure, a “constraint group lookup table” is a lookup table that relates the empty table constraint to one or more constraint groups. A “lookup table,” for the purposes of this disclosure, is an array of data that maps input values to output values. A lookup table may be used to replace a runtime computation with an array indexing operation. In an embodiment, the lookup table may include interpolation. For the purposes of this disclosure, an “interpolation” refers to a process for estimating values that lie between the range of known data. As a non-limiting example, the lookup table may include an output value for each of input values. When the lookup table does not define the input values, then the lookup table may estimate the output values based on the nearby table values. In another embodiment, the lookup table may include an extrapolation. For the purposes of this disclosure, an “extrapolation” refers to a process for estimating values that lie beyond the range of known data. As a non-limiting example, the lookup table may linearly extrapolate the nearest data to estimate an output value for an input beyond the data.

With continued reference to FIG. 1, in some embodiments, processor 104 may ‘lookup’ given empty table constraint 136 to find corresponding constraint groups using a constraint group lookup table. As a non-limiting example, constraint group lookup table may correlate empty table constraint 136 of a specific gender of female to a female group of gender group of constraint group. As another non-limiting example, constraint group lookup table may correlate empty table constraint 136 of a specific skill level of intermediate to an intermediate group of skill level group of constraint group. As another non-limiting example, constraint group lookup table may correlate empty table constraint 136 of a specific education history of postdoctoral to a postdoctoral group of education history group of constraint group. As another non-limiting example, constraint group lookup table may correlate empty table constraint 136 of a specific service experience of 4 years or more to a 3-5 years group of service experience group of constraint group. As another non-limiting example, constraint group lookup table may correlate empty table constraint 136 of a specific numerical value of review of provider 116 of 4.4 or more to a 4-5 review group of review group of constraint group. As another non-limiting example, constraint group lookup table may correlate empty table constraint 136 of a specific keyword of review of provider 116 of ‘hardworking’ to a ‘hardworking’ group of review group of constraint group.

With continued reference to FIG. 1, in some embodiments, constraint group may include a constraint weight. For the purposes of this disclosure, a “constraint weight” is a predetermined numerical value that indicates importance of an empty table constraint in relation to one or more other empty table constraints. As a non-limiting example, constraint weight may include any numerical value in a set range. For example, and without limitation, if a set range includes 1 to 5, then constraint weight may include any numerical value in the set range of 1 to 5. For example, and without limitation, if a set range includes 1 to 10, then constraint weight may include any numerical value in the set range of 1 to 10. For example, and without limitation, if a set range includes 1 to 20, then constraint weight may include any numerical value in the set range of 1 to 20. In some embodiments, higher constraint weight may indicate greater importance that user 124 puts for empty table constraint 136 of constraint group. As a non-limiting example, age group that includes constraint weight of 5 may have greater importance than gender group that includes constraint weight of 1. As another non-limiting example, service experience group that includes constraint weight of 10 may have greater importance than education history group that includes constraint weight of 6. In some embodiments, constraint weight may be stored in timetable database 120. In some embodiments, constraint weight may be retrieved in timetable database 120. In some embodiments, user 124 may manually input constraint weight.

With continued reference to FIG. 1, memory 108 contains instructions configuring processor 104 to obtain provider data 144. For the purposes of this disclosure, “provider data” is data related to a plurality of providers that provides a service. In some embodiments, provider data 144 may be stored in timetable database 120. In some embodiments, provider data 144 may be retrieved from timetable database 120.

With continued reference to FIG. 1, provider data 144 includes provider information 140. For the purposes of this disclosure, “provider information” is information related to each of a plurality of providers and the providers' service. As a non-limiting example, provider information 140 may include a name, gender, contact information, related entity, or the like. As another non-limiting example, provider information 140 may include service experience, service area, referral, review, service cost, specialty, education history, certification, skill, skill level, or the like. For example, and without limitation, gender of provider information 140 may include male, female, non-binary, does not want to answer, or the like. For example, and without limitation, service experience of provider information 140 may include less than 1 year, between 1-2 years, 2-3 years, 3-5 years, 6-10 years, more than 10 years, or the like. For example, and without limitation, education history of provider information 140 may include associate, bachelor, master, doctoral, postdoctoral, Juris Doctor (J.D.) for law, Doctor of Medicine (M.D.) for medicine, Doctor of Pharmacy (Pharm.D.) for pharmacy, and Doctor of Dental Surgery (D.D.S.), Doctor of Dental Medicine (D.M.D.) for dentistry, or the like. For example, and without limitation, skill level of provider information 140 may include beginner, intermediate, advanced, expert, or the like. For example, and without limitation, review of provider information 140 may include a numerical value in a set range of 5, 10, or any range thereof. Review of provider information 140, in a non-limiting example, may include 4.4 in a set range of 5. Review of provider information 140, in another non-limiting example, may include 2 in a set range of 10. In another non-limiting example, review of provider 116 may include a string that includes a plurality of words. As another non-limiting example, provider information 140 may include a resume. For the purposes of this disclosure, a “resume” is a formal document that displays a provider's professional background and relevant skills. As another non-limiting example, provider information 140 may include a self-description. For the purposes of this disclosure, a “self-description”is a statement or portrayal of a provider oneself. For example, and without limitation, self-description may include personal background, skills and abilities, personal traits, accomplishments and achievements, interest and passions, or the like. In some embodiments, processor 104 may obtain a resume, review of provider 116 and self-description by using a web crawler. The web crawler disclosed herein is further described above. Examples above are merely examples and persons skilled in the art, upon reviewing the entirety of this disclosure, may appreciate various provider information 140 that can be used in apparatus 100.

With continued reference to FIG. 1, provider data 144 includes provider time information 160. For the purposes of this disclosure, “provider time information” is information related to providers' available time to provide a service to a user. In an embodiment, provider time information 160 may include provider 116's available times of a day, week, month, year, or the like. As a non-limiting example, provider time information 160 may include specific time. For example, and without limitation, provider time information 160 may include 8 am to 10 am, 9 am to 5 pm, 10 pm to 4 am, 11 am to 12 am, 1:30 pm to 4:30 pm, 7:30 pm to 8 pm, 11:45 am to 2:30 pm, anytime, or the like. As another non-limiting example, provider time information 160 may include Monday, Tuesday, Wednesday, Thursday, Friday, Saturday, Sunday or any combination of days. For example, and without limitation, provider time information 160 may include Monday and Tuesday, Monday, Wednesday and Friday, Saturday and Sunday (such as weekends), Tuesday and Thursday, Monday to Saturday, Monday to Sunday (such as all days or any days), or the like. As another non-limiting example, provider time information 160 may include January, February, March, April, May, June, July, August, September, October, November, December, or any combination of months. For example, and without limitation, provider time information 160 may include January to December (all months or any months), January and May, March to July, October to December, or the like. As another non-limiting example, provider time information 160 may include 2023, 2024, 2025, or the like. As another non-limiting example, provider time information 160 may include a specific date. For example, and without limitation, provider time information 160 may include May 8^{th} of 2023 July 11^{th} of 2023 December 12^{th} to 20^{th} of 2023 April 2^{nd} to August 1^{st} of 2024, or the like. In some embodiments, provider time information 160 may include any combination of provider time information 160. In a non-limiting example, provider time information 160 may include 6 am to 10 am every Tuesday and Thursday in July of 2023. In another non-limiting example, provider time information 160 may include 10 am to 12 pm every Monday, Wednesday and Thursday from May to June of 2023 and 3 pm to 8 pm every Tuesday and Friday from May to June of 2023. In another non-limiting example, provider time information 160 may include 8:30 am to 9:15 am on May 25^{th} of 2023 and 5 pm to 7 pm on May 28^{th} of 2023. In another non-limiting example, provider time information 160 may include anytime during every day in September. Examples of provider time information 160 above are merely examples and persons skilled in the art, upon reviewing the entirety of this disclosure, may appreciate various provider time information 160 that can be used in apparatus 100.

With continued reference to FIG. 1, in some embodiments, provider data 144 may include a provider preference. For the purposes of this disclosure, a “provider preference” is an attribute of a user or the user's timetable (a first timetable) to which a provider has more personal inclination towards over other attributes of the user or the user's timetable. As a non-limiting example, provider preference may include preferred user location, preferred types of empty table task, preferred values of user 124's review, preferred time slot to work, or the like. In some embodiments, provider 116 may rank preferred time slot to work. As a non-limiting example, provider 116 may rank days of the week or month, times of the day, or the like, based on the provider 116's preference for work. In some embodiments, provider preference may include a preference threshold. For the purposes of this disclosure, a “preference threshold” is a minimum number of a provider preference required for an empty table of a first timetable. As a non-limiting example, preference threshold may include a numerical value. For example, and without limitation, when provider preference of provider 116 includes preference threshold of 2 and empty table of first timetable includes any two empty table information 128 that matches with the provider preference, then processor 104 may generate a second timetable 156 for the provider 116 (selected provider 152). In a non-limiting example, if the empty table of the first timetable includes empty table information 128 less than preference threshold, then processor 104 may not generate second timetable 156 for the provider 116 (selected provider 152). The second timetable 156 disclosed herein is further described below. In some embodiments, provider data 144 may include a provider aversion. For the purposes of this disclosure, a “provider aversion” is an attribute of a user or the user's timetable (a first timetable) that a provider have less personal inclination or dislike towards over other attributes of the user or the user's timetable. As a non-limiting example, provider aversion may include user location, types of empty table task, value of user 124's review that provider 116 have less personal inclination or dislike. In a non-limiting example, if first timetable data 112 of first timetable includes any empty table information 128 that matches with provider aversion, processor 104 may not generate a second timetable 156 for a provider 116 (selected provider 152).

With continued reference to FIG. 1, in some embodiments, processor 104 may obtain provider data 144 from timetable database 120. In some embodiments, processor 104 may obtain provider data 144 using a timetable application programming interface (API). In some embodiments, processor 104 may be configured to call timetable APIs for provider data 144. As a non-limiting example, a timetable API may include Google Calendar API, Microsoft Graph API, Apple Calendar API, Calendly API, Timely API, or the like. In some embodiments, processor 104 may be configured to obtain provider data 114, such as provider information 140, using API provided by social media sites, job-posting sites, or the like. As a non-limiting example, social media sites and/or job-posting sites may include INDEED, MONSTER, LINKEDIN, or the like.

With continued reference to FIG. 1, in some embodiments, processor 104 may obtain provider data 144 from a provider device 164. For the purposes of this disclosure, a “provider device” is any device a provider uses to input data. As a non-limiting example, provider 116 may input provider data 144, confirm feature input 168, provider response, and the like. For example, and without limitation, provider 116 may manually input provider information 140, provider time information 160, provider preference, preference threshold, provider aversion, or the like. In an embodiment, provider device 164 may include a personal device. As a non-limiting example, personal device may include a laptop, tablet, mobile phone, smart watch, or things of the like. In some embodiments, provider device 164 may include an interface configured to receive inputs from provider 116. In some embodiments, provider 116 may have a capability to process, store or transmit any information independently. In another embodiment, provider device 164 may include a shared device. In some embodiments, shared device may be used by different providers 116 at different times. As a non-limiting example, shared device may include desktop computers, kiosks, smartphones, laptops, tablets, or the like. Provider device 164 disclosed herein is further described below.

With continued reference to FIG. 1, in some embodiments, processor 104 may be configured to classify provider data 144 into one or more provider groups. For the purposes of this disclosure, a “provider group” is a set of associative provider data. In some embodiments, each provider group may include one or more providers 116 and associated provider data 144. As a non-limiting example, provider group may include a first provider, second provider, third provider, fourth provider group, or the like. Examples above are merely examples and persons skilled in the art, upon reviewing the entirety of this disclosure, may appreciate various provider groups that can be used in apparatus 100. In some embodiments, provider group may be stored in timetable database 120. In some embodiments, provider group may be retrieved from timetable database 120.

With continued reference to FIG. 1, in some embodiments, processor 104 may be configured to classify provider data 144 into one or more provider groups using a provider group classifier. For the purposes of this disclosure, a “provider group classifier” is a machine-learning model, such as a mathematical model, neural net, or program generated by a machine learning algorithm known as a “classification algorithm,” that sorts provider data related inputs into categories or bins of data, outputting one or more provider groups associated therewith. The provider group classifier disclosed herein may be consistent with a classifier disclosed with respect to FIG. 2. In some embodiments, provider group classifier may be trained with provider group training data correlating a provider data set to one or more provider groups. The training data disclosed herein is further disclosed with respect to FIG. 2. In some embodiments, provider group training data may be stored in a timetable database 120. In some embodiments, provider group training data may be received from one or more users, timetable database 120, external computing devices, and/or previous iterations of processing. As a non-limiting example, provider group training data may include instructions from a user, who may be an expert user, a past user in embodiments disclosed herein, or the like, which may be stored in memory and/or stored in timetable database 120, where the instructions may include labeling of training examples.

With continued reference to FIG. 1, in some embodiment, provider group classifier may be trained with provider group training data correlating a provider data set to one or more provider groups. As a non-limiting example, provider group training data may correlate provider data 144 of a first provider and provider information 140, provider time information 160, provider preference, provider aversion, or the like of the first provider to a first provider group. As another non-limiting example, provider group training data may correlate provider data 144 of a second provider and provider information 140, provider time information 160, provider preference, provider aversion, or the like of the second provider to a second provider group. As another non-limiting example, provider group training data may correlate provider data 144 of a third provider and provider information 140, provider time information 160, provider preference, provider aversion, or the like of the third provider to a third provider group. Examples above are merely examples and persons skilled in the art, upon reviewing the entirety of this disclosure, may appreciate various provider group training data that can be used in apparatus 100.

With continued reference to FIG. 1, memory 108 contains instructions configuring processor 104 to determine at least a general provider 148. For the purposes of this disclosure, a “general provider” is a provider who is selected for an empty table of a first timetable, wherein their provider time information aligns with empty time information of the empty table of the first timetable. Processor 104 is configured to determine general provider 148 as a function of provider time information 160 of provider data 144 and empty time information 132 of empty table information 128 of first timetable data 112. In a non-limiting example, processor 104 may be configured to determine general provider 148 as a function of provider group and empty table group. In another non-limiting example, processor 104 may be configured to determine general provider 148 as a function of provider time information 160 of provider group and empty time information 132 of empty table group. As a non-limiting example, general provider 148 may include a plurality of providers 116, where their provider time information 160 aligns with empty time information 132 of empty table information 128 of first timetable data 112. As another non-limiting example, general provider 148 may include a plurality of providers 116, where empty time information 132 of empty table information 128 of first timetable data 112 is within their provider time information 160 of provider data 144. For example, and without limitation, if empty time information 132 includes 8:30 am to 9:15 am on May 25^{th} of 2023 and provider time information 160 of a provider 116 includes 8 am to 10 am on May 25^{th} of 2023, processor 104 may determine the provider 116 as general provider 148. For example, and without limitation, if empty time information 132 includes 5 pm to 7 pm on May 28^{th} of 2023 and provider time information 160 of a provider 116 includes 10 am to 10 pm on May 28^{th} of 2023, processor 104 may determine the provider 116 as general provider 148. For example, and without limitation, if empty time information 132 includes 8:30 am to 9:15 am on May 25^{th} of 2023 and 5 pm to 7 pm on May 28^{th} of 2023 and provider time information 160 of a provider 116 includes anytime on May 28^{th} of 2023, processor 104 may determine the provider 116 as general provider 148. For example, and without limitation, if empty time information 132 includes 8:30 am to 9:15 am on May 25^{th} of 2023 and 5 pm to 7 pm on May 28^{th} of 2023 and provider time information 160 of a provider 116 includes anytime during every day on May, processor 104 may determine the provider 116 as general provider 148. For another example, and without limitation, if empty time information 132 includes 8:30 am to 9:15 am on May 25^{th} of 2023 and 5 pm to 7 pm on May 28^{th} of 2023 and provider time information 160 of a provider 116 includes anytime on June 4^{th} of 2023, processor 104 may not determine the provider 116 as general provider 148.

With continued reference to FIG. 1, in some embodiments, processor 104 may determine general provider 148 using a general provider machine learning model 172. For the purposes of this disclosure, a “general provider machine learning model” is a machine learning model that determines a general provider. The general provider machine learning model disclosed herein may be consistent with a machine learning model disclosed with respect to FIG. 2. The general provider machine learning model may be trained with general provider training data. For the purposes of this disclosure, “general provider training data” is training data that is used to train a general provider machine learning model. The training data disclosed herein is further disclosed with respect to FIG. 2. In some embodiments, general provider training data may correlate empty time information 132 and provider time information 160 to output general provider 148. As a non-limiting example, general provider training data may correlate an empty time information data set and provider time information data set and may output general provider 148. In some embodiments, general provider training data may be received from a user, timetable database 120, external computing devices, and/or previous iterations of processing. As a non-limiting example, general provider training data may include instructions from the user stored in timetable database 120, where the instructions may include labeling examples.

With continued reference to FIG. 1, memory 108 contains instructions configuring processor 104 to determine a selected provider 152 among at least a general provider 148. For the purposes of this disclosure, a “selected provider” is a general provider who is selected for an empty table of a first timetable, where their provider information aligns with at least an empty table constraint of the empty table of the first timetable. Processor 104 is configured to determine selected provider 152 as a function of provider information 140 of provider data 144 and empty table constraint 136 of empty table information 128 of first timetable data 112. In a non-limiting example, processor 104 may be configured to determine selected provider 152 as a function of provider group and empty table constraint group of empty table group. In another non-limiting example, processor 104 may be configured to determine selected provider 152 as a function of provider information 140 of provider group and empty table constraint 136 of empty table constraint group. As a non-limiting example, selected provider 152 may include general provider 148 who has provider information 140 aligns with empty table constraint 136 of empty table information 128 of first timetable data 112. For example, and without limitation, if empty table constraint 136 includes specific service experience of more than 10 years and specific skill level of expert and general provider 148 includes service experience of 13 years and skill level of expert, then processor 104 may determine the general provider 148 as selected provider 152. For example, and without limitation, if empty table constraint 136 includes specific education history of master or higher and specific numerical value of a review of provider 116 of 8 or higher in a set range of 10 and general provider 148 includes education history of master and numerical value of a review of provider 116 of 8.8 in a set range of 10, then processor 104 may determine the general provider 148 as selected provider 152. For another example, and without limitation, if empty table constraint 136 includes specific service experience of more than 10 years and specific skill level of expert and general provider 148 includes service experience of 5 years and skill level of intermediate, then processor 104 may not determine the general provider 148 as selected provider 152. For another example, and without limitation, if empty table constraint 136 includes specific education history of master and specific numerical value of a review of provider 116 of 8 or more in a set range of 10 and general provider 148 includes education history of master and numerical value of a review of provider 116 of 6 in a set range of 10, then processor 104 may not determine the general provider 148 as selected provider 152.

With continued reference to FIG. 1, in some embodiments, processor 104 may determine selected provider 152 as a function of a provider keyword and a constraint keyword. As a non-limiting example, when provider keyword of provider information 140 of general provider 148 and constraint keyword of empty table constraint 136 matches, processor 104 may determine the general provider 148 as selected provider 152. As another non-limiting example, when provider keyword of provider information 140 of general provider 148 and constraint keyword of empty table constraint 136 does not match, processor 104 may not determine the general provider 148 as selected provider 152. For the purposes of this disclosure, a “provider keyword” is a keyword that is derived from provider information. As a non-limiting example, provider keyword may include keywords related to name of provider 116, gender, related entity, service experience, service area, referral, review, service cost, specialty, education history, certification, skill, skill level, or the like. As another non-limiting example, provider keyword may include keyword of self-description, keyword of review of provider 116, or the like. In some embodiments, provider keyword may be stored in timetable database 120. In some embodiments, provider keyword may be retrieved from timetable database 120. In some embodiments, provider 116 may manually input provider keyword. In some embodiments, provider keyword may be derived from provider information using a language processing module as described below. For the purposes of this disclosure, a “constraint keyword” is a keyword that is derived from an empty table constraint. As a non-limiting example, constraint keyword may include keywords related to a specific skill, skill level, education history, service experience, age, gender, or the like. As another non-limiting example, constraint keyword may include keyword of self-description, keyword of review of provider 116, or the like. In some embodiments, constraint keyword may be stored in timetable database 120. In some embodiments, constraint keyword may be retrieved from timetable database 120. In some embodiments, user 124 may manually input constraint keyword. In some embodiments, constraint keyword may be derived from empty table constraint 136 using a language processing module as described below.

With continued reference to FIG. 1, in some embodiments, processor 104 may determine selected provider 152 as a function of provider quantity of empty table information 128. As a non-limiting example, if provider quantity includes 2, then processor 104 may determine two selected providers 152. As another non-limiting example, if provider quantity includes 1, the processor 104 may determine one selected provider 152. As another non-limiting example, if provider quantity includes 12, the processor 104 may determine twelve selected providers 152. In some embodiments, selected provider 152 may be determined by processor 104 for multiple empty tables of first timetable. As a non-limiting example, selected provider 152 may be determined for a first empty table, second empty table and third empty table. In some embodiments, multiple selected providers 152 may be determined by processor 104 for a multiple empty tables. As a non-limiting example, first selected provider may be determined for a first empty table, second empty table and third empty table and second selected provider may be determined for the first empty table and a fourth empty table.

With continued reference to FIG. 1, in some embodiments, processor 104 may determine selected provider 152 as a function of provider preference and preference threshold of provider data 144. As a non-limiting example, if provider preference of general provider 148 includes preferred user location, preferred types of empty table task, preferred values of user 124's review and preference threshold includes 1 and provider information 140 includes user location that aligns with the preferred user location, a numerical value of user 124's review that aligns with the preferred values of user 124's review and types of empty table task that does not align with the preferred types of empty table task, then processor 104 may determine the general provider 148 as selected provider 152. As another non-limiting example, if provider preference of general provider 148 includes preferred user location, preferred types of empty table task, preferred values of user 124's review and preference threshold includes 2 and provider information 140 includes user location that does not align with the preferred user location, a numerical value of user 124's review that aligns with the preferred values of user 124's review and types of empty table task that does not align with the preferred types of empty table task, then processor 104 may not determine the general provider 148 as selected provider 152.

With continued reference to FIG. 1, in some embodiments, processor 104 may determine selected provider 152 as a function of an empty table keyword of empty table information 128. For the purposes of this disclosure, an “empty table keyword” is a keyword that is derived from user information and empty table task. In some embodiments, processor 104 may analyze empty table information 128 using a language processing module to obtain empty table keyword. The language processing module is further described below. As a non-limiting example, empty table keyword may include keywords of empty table task or user information. For example, and without limitation, empty table keyword may include address, name of employee, name of chief executive officer, name of any personnels related to empty table or user 124, or review of user 124. For example, and without limitation, empty table keyword may include keywords related to a description of actions and responsibilities involved in working within an empty table such as but not limited to ‘patient consultation,’ ‘treatment planning,’ ‘medical procedures,’ ‘surgical interventions,’ ‘monitoring,’ ‘follow-up,’ ‘health education,’ ‘rehabilitation,’ ‘mental health service,’ ‘care coordination,’ or the like. Examples above are merely examples and persons skilled in the art, upon reviewing the entirety of this disclosure, may appreciate various empty table keywords that can be used in apparatus 100. In some embodiments, empty table keyword may be stored in timetable database 120. In some embodiments, empty table keyword may be retrieved from timetable database 120. In some embodiments, user 124 may manually input empty table keyword. In some embodiments, processor 104 may compare empty table keyword and provider preference and determine selected provider 152 as a function of the comparison. As a non-limiting example, when provider preference of general provider 148 includes preferred types of empty table task that is related to mental health service and empty table keyword includes ‘mental health service’ or ‘mental,’ then processor 104 may determine general provider 148 as selected provider 152. As another non-limiting example, when provider preference of general provider 148 includes preferred keyword for user 124's review of ‘family-like workplace’ and empty table keyword includes ‘family-like workplace,’ then processor 104 may determine general provider 148 as selected provider 152.

With continued reference to FIG. 1, in come embodiments, processor 104 may use a language processing module to find a keyword. As a non-limiting example, language processing module may find empty table keyword, provider keyword, constraint keyword, or the like. The language processing module may be configured to extract, from empty table information 128, provider information 140 or empty table constraint 136, one or more words. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

With continued reference to FIG. 1, language processing module may operate to produce a language processing model. Language processing model may include a program automatically generated by processor 104 and/or language processing module to produce associations between one or more words extracted from empty table information 128 and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given empty table information 128 is or is not indicating a category semantic meaning. Whether a phrase, sentence, word, or other textual element in empty table information 128 constitutes a positive or negative indicator may be determined, in an embodiment, by mathematical associations between detected words, comparisons to phrases and/or words indicating positive and/or negative indicators that are stored in memory at computing device, or the like.

With continued reference to FIG. 1, language processing module and/or diagnostic engine may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted words, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

With continued reference to FIG. 1, generating the language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

With continued reference to FIG. 1, language processing module may use a corpus of documents to generate associations between language elements in a language processing module, and diagnostic engine may then use such associations to analyze words extracted from one or more documents and determine that the one or more documents indicate significance of a category. In an embodiment, language module and/or Processor 104 may perform this analysis using a selected set of significant documents, such as documents identified by one or more experts as representing good information; experts may identify or enter such documents via graphical user interface or may communicate identities of significant documents according to any other suitable method of electronic communication, or by providing such identity to other persons who may enter such identifications into processor 104. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, diagnostic engine may automatically obtain the document using such an identifier, for instance by submitting a request to a database or compendium of documents such as JSTOR as provided by Ithaka Harbors, Inc. of New York.

With continued reference to FIG. 1, in some embodiments, processor 104 may determine selected provider 152 as a function of provider aversion of provider data 144. As a non-limiting example, if provider aversion of general provider 148 includes user location and types of empty table task that the provider 116 have less personal inclination or dislike and provider information 140 includes user location that does not align with the provider aversion but types of empty table task that aligns with the provider aversion, then processor 104 may not determine general provider 148 as selected provider 152. As another non-limiting example, if provider aversion of general provider 148 includes user location and types of empty table task that the provider 116 have less personal inclination or dislike and provider information 140 includes user location that does not align with the provider aversion and types of empty table task that does not align with the provider aversion, then processor 104 may determine the general provider 148 as selected provider 152. In some embodiments, processor 104 may compare empty table keyword and provider aversion and determine selected provider 152 as a function of the comparison. As a non-limiting example, when provider aversion of general provider 148 includes preferred types of empty table task that is related to mental health service and empty table keyword includes ‘mental health service’ or ‘mental,’ then processor 104 may not determine the general provider 148 as selected provider 152. As another non-limiting example, when provider aversion of general provider 148 includes preferred keyword for user 124's review of ‘family-like workplace’ and empty table keyword includes ‘family-like workplace,’ then processor 104 may not determine the general provider 148 as selected provider 152.

With continued reference to FIG. 1, in some embodiments, processor 104 may determine selected provider 152 as a function of constraint group and constraint weight of the constraint group. As a non-limiting example, if a first general provider includes provider information 140 that aligns with empty table constraint 136 of constraint group that includes constraint weight of 5 and second general provider includes provider information 140 that aligns with empty table constraint 136 of constraint group that includes constraint weight of 8, then processor 104 may determine the second general provider as selected provider 152. As another non-limiting example, if a first general provider includes provider information 140 that aligns with empty table constraint 136 of constraint group that includes constraint weight of 9, second general provider includes provider information 140 that aligns with empty table constraint 136 of constraint group that includes constraint weight of 1 and third general provider includes provider information 140 that aligns with empty table constraint 136 of constraint group that includes constraint weight of 2, then processor 104 may determine the first general provider as selected provider 152. In some embodiments, processor 104 may determine selected provider 152 as a function of a sum of constraint weight. In a non-limiting example, if a first general provider includes provider information 140 that aligns with empty table constraint 136 of constraint group that includes constraint weight of 5 and another provider information 140 that aligns with another empty table constraint 136 of another constraint group that includes constraint weight of 9 and second general provider includes provider information 140 that aligns with empty table constraint 136 of constraint group that includes constraint weight of 8 and another provider information 140 that aligns with another empty table constraint 136 of another constraint group that includes constraint weight of 1, then processor 104 may determine the first general provider as selected provider 152. In some embodiments, when there are a plurality of selected providers 152 that aligns with empty table constraint 136 for an empty table of first timetable, then processor 104 may determine selected provider 152 as a function of provider preference or provider aversion. As a non-limiting example, when both first general provider and second general provider includes equivalent sum of empty table constraint 136, then processor 104 may analyze provider preference and/or provider aversion and determine selected provider 152 as a function of the analysis.

With continued reference to FIG. 1, in some embodiments, processor 104 may determine selected provider 152 using a selected provider machine learning model 176. For the purposes of this disclosure, a “selected provider machine learning model” is a machine learning model that determines a selected provider. The selected provider machine learning model disclosed herein may be consistent with a machine learning model disclosed with respect to FIG. 2. The selected provider machine learning model may be trained with selected provider training data. For the purposes of this disclosure, “selected provider training data” is training data that is used to train a selected provider machine learning model. The training data disclosed herein is further disclosed with respect to FIG. 2. In some embodiments, selected provider training data may be received from a user, timetable database 120, external computing devices, and/or previous iterations of processing. As a non-limiting example, selected provider training data may include instructions from the user stored in timetable database 120, where the instructions may include labeling examples.

With continued reference to FIG. 1, in some embodiments, selected provider training data may correlate empty table constraint 136 and provider information 140 to output selected provider 152. As a non-limiting example, selected provider training data may correlate an empty table constraint data set and provider information data set and may output selected provider 152. For example, and without limitation, selected provider training data may correlate provider keyword and constraint keyword and output selected provider 152. As another non-limiting example, selected provider training data may correlate empty table constraint 136, provider information 140 and provider quantity and may output selected provider 152. As another non-limiting example, selected provider training data may correlate empty table constraint 136, provider information 140, preference threshold and provider preference and output selected provider 152. For example, and without limitation, selected provider training data may correlate empty table keyword and provider preference and output selected provider 152. As another non-limiting example, selected provider training data may correlate empty table constraint 136, provider information 140 and provider aversion and output selected provider 152. For example, and without limitation, selected provider training data may correlate empty table keyword and provider aversion and output selected provider 152. As another non-limiting example, selected provider training data may correlate empty table constraint 136, provider information 140, constraint group and constraint weight and output selected provider 152.

With continued reference to FIG. 1, in some embodiments, processor 104 may be configured to determine selected provider 152 using an objective function. In some embodiments, processor 104 may compute a score associated with each provider data 144 and first timetable data 112 and select selected provider 152 to minimize and/or maximize the score, depending on whether an optimal result is represented, respectively, by a minimal and/or maximal score; a mathematical function, described herein as an “objective function,” may be used by processor 104 to score each possible pairing. Objective function may be based on one or more objectives as described below. In various embodiments a score of a particular selected provider 152 may be based on a combination of one or more factors, including provider information 140, provider time information 160, provider preference, provider aversion, time slot, empty table task, empty time information 132, empty table constraint 136, user information, provider quantity, or the like. Each factor may be assigned a score based on predetermined variables. In some embodiments, the assigned scores may be weighted or unweighted.

With continued reference to FIG. 1, in some embodiments, optimization of objective function may include performing a greedy algorithm process. A “greedy algorithm” is defined as an algorithm that selects locally optimal choices, which may or may not generate a globally optimal solution. For instance, processor 104 may select selected provider 152 so that scores associated therewith are the best score for each empty table of first timetable.

With continued reference to FIG. 1, in some embodiments, objective function may be formulated as a linear objective function, which processor 104 may solve using a linear program such as without limitation a mixed-integer program. A “linear program,” as used in this disclosure, is a program that optimizes a linear objective function, given at least a constraint. For instance, constraint may include provider information 140, provider time information 160, provider preference, provider aversion, time slot, empty table task, empty time information 132, empty table constraint 136, user information, provider quantity, or the like. In various embodiments, system 100 may determine selected provider 152 that maximizes a total score subject to a constraint that includes provider information 140, provider time information 160, provider preference, provider aversion, time slot, empty table task, empty time information 132, empty table constraint 136, user information, provider quantity, or the like. A mathematical solver may be implemented to solve for the set provider information 140, provider time information 160, provider preference, provider aversion, time slot, empty table task, empty time information 132, empty table constraint 136, user information, provider quantity, or the like that maximizes scores; mathematical solver may implemented on processor 104 and/or another device in apparatus 100, and/or may be implemented on third-party solver.

With continued reference to FIG. 1, in some embodiments, optimizing objective function may include minimizing a loss function, where a “loss function” is an expression an output of which an optimization algorithm minimizes to generate an optimal result. As a non-limiting example, processor 104 may assign variables relating to a set of parameters, which may correspond to score components as described above, calculate an output of mathematical expression using the variables, and select selected provider 152 that produces an output having the lowest size, according to a given definition of “size,” of the set of outputs representing each of plurality of candidate ingredient combinations; size may, for instance, included absolute value, numerical size, or the like. Selection of different loss functions may result in identification of different potential pairings as generating minimal outputs.

With continued reference to FIG. 1, memory 108 contains instructions configuring processor 104 to generate a second timetable 156. For the purposes of this disclosure, a “second timetable” is a schedule that outlines the specific timing and sequence of events, activities, or tasks of a selected provider to deliver a service to a user. Processor 104 is configured to generate second timetable 156 as a function of selected provider 152. As a non-limiting example, second timetable 156 may include empty table information 128 of an empty table that selected provider 152 is determined by processor 104 to deliver a service. In some embodiments, second timetable 156 may be stored in timetable database 120. In some embodiments, second timetable may be retrieved from timetable database 120.

With continued reference to FIG. 1, generating second timetable 156 includes receiving a confirm feature input 168 from provider device 164. Generating second timetable 156 includes generating second timetable 156 as a function of confirm feature input 168 and selected provider 152. For the purposes of this disclosure, a “confirm feature input” is a feature of a second timetable that allows a processor to generate the second table. In some embodiments, provider 116 manually input confirm feature input 168 using provider device 164. As a non-limiting example, provider 116 may input confirm feature input 168 using user interface of provider device 164. The user interface disclosed herein is further described below. For example, and without limitation, provider 116 may touch a button (graphical user interface) for inputting confirm feature input 168 on a touchscreen of provider device 164. For example, and without limitation, provider 116 may click an option for inputting confirm feature input 168 using provider device 164. In some embodiments, confirm feature input 168 may be stored in timetable database 120. In some embodiments, confirm feature input 168 may be retrieved from timetable database 120.

With continued reference to FIG. 1, in an embodiment, confirm feature input 168 may include an automatically generating a second timetable input. For the purposes of this disclosure, an “automatically generating a second timetable input” is an input from a provider related to a method or process for generating a second timetable by automatically generating a second table without a provider response. As a non-limiting example, if confirm feature input includes automatically generating a second timetable input, then processor 104 may automatically generate a second timetable 156 as the processor 104 determines selected provider 152.

With continued reference to FIG. 1, in another embodiment, confirm feature input 168 may include a generating a second timetable as a function of a provider response input. For the purposes of this disclosure, an “generating a second timetable as a function of a provider response input” is an input from a provider related to a method or process for generating a second timetable by generating a second table using a provider response. For the purposes of this disclosure, a “provider response” is an input from a provider using a provider device. As a non-limiting example, provider response may include an approval. For the purposes of this disclosure, an “approval” is the act of accepting to be a selected provider for an empty table of first timetable. In some embodiments, if processor 104 receives approval of provider response, then the processor 104 may generate second timetable 156. As another non-limiting example, provider response may include a rejection. For the purposes of this disclosure, a “rejection” is the act of refusing to be a selected provider for an empty table of first timetable. In some embodiments, if processor 104 receives rejection of provider response from a first provider, then the processor 104 may determine another general provider 148 as selected provider 152.

With continued reference to FIG. 1, in some embodiments, if confirm feature input 168 includes generating a second timetable as a function of a provider response input, processor 104 may generate a confirm alert and transmit the confirm alert to provider device 164. In a non-limiting example, provider 116 may input provider response as the provider 116 receives confirm alert. For the purposes of this disclosure, a “confirm alert” is an indication to inform a user or provider about determination of a selected provider for an empty table of a user's timetable (first timetable). In some embodiments, processor 104 may provide confirm alert to provider 116 on provider device 164. In some embodiments, confirm alert may include audio, text, image, vibration, and the like. In some embodiments, confirm alert may include a text message, notification sound, phone call, notification banner, or the like. As a non-limiting example, processor 104 may generate confirm alert to notify provider 116 that the provider 116 is selected as selected provider 152. As another non-limiting example, processor 104 may generate confirm alert to notify user 124 that an empty table of first timetable is filled with selected provider 152. In some embodiments, confirm alert may include a reminder. For the purposes of this disclosure, a “reminder” is a notification for prompting a user or provider to remember something. As a non-limiting example, reminder may include prompting provider 116 or user 124 to input provider response or user response. In some embodiments, processor 104 may be configured to generate confirm alert as the processor 104 determines selected provider 152. In some embodiments, processor 104 may be configured to generate confirm alert as the processor 104 generates second timetable 156.

With continued reference to FIG. 1, in some embodiments, provider 116 may input provider response using provider device 164. In some embodiments, processor 104 may be further configured to generate a user interface displaying second timetable 156, empty table information 128, provider data 144, and the like. For the purposes of this disclosure, a “user interface” is a means by which a user or provider and a computer system interact; for example through the use of input devices and software. A user interface may include a graphical user interface (GUI), command line interface (CLI), menu-driven user interface, touch user interface, voice user interface (VUI), form-based user interface, any combination thereof and the like. In some embodiments, user interface may operate on and/or be communicatively connected to a decentralized platform, metaverse, and/or a decentralized exchange platform associated with user 124 or provider 116. In some embodiments, user 124 or provider 116 may interact with the use interface using a computing device distinct from and communicatively connected to processor 104. For example, a smart phone, smart, tablet, or laptop operated by user 124 or provider 116. In an embodiment, user interface may include a graphical user interface. A “graphical user interface,” as used herein, is a graphical form of user interface that allows a user or provider to interact with electronic devices. In some embodiments, GUI may include icons, menus, other visual indicators or representations (graphics), audio indicators such as primary notation, and display information and related user controls. A menu may contain a list of choices and may allow user 124 or provider 116 to select one from them. A menu bar may be displayed horizontally across the screen such as pull-down menu. When any option is clicked in this menu, then the pull-down menu may appear. A menu may include a context menu that appears only when user 124 or provider 116 performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access.

With continued reference to FIG. 1, in some embodiments, processor 104 may be configured to transmit data related to selected provider 152 to user device 156. In some embodiments, processor 104 may be configured to generate first timetable using the transmitted data. As a non-limiting example, first timetable may include provider information 140 of selected provider 152 for an empty table of the first timetable. For example, and without limitation, empty table of first timetable may include service experience, education history, review of provider 116, gender, skill level, self-description, contact information, name, related entity, or the like. In some embodiment, first timetable may be consistent with second timetable 156.

With continued reference to FIG. 1, in some embodiments, processor 104 may be configured to receive a user response from user device 156. As a non-limiting example, user 124 may manually input user response using user device 156. In some embodiments, processor 104 may be further configured to generate a user interface displaying first timetable, first timetable data 112, selected provider 152, provider information 140, and the like. For the purposes of this disclosure, a “user response” is an input from a user using a provider device. As a non-limiting example, user response may include an approval. For example, and without limitation, user 124 may accept selected provider 152 for an empty table of user 124's timetable (first timetable). In a non-limiting example, if processor 104 receives approval of user response, then the processor 104 may generate second timetable 156. In another non-limiting example, if processor 104 receives approval of user response, then the processor 104 may generate and transmit confirm alert to selected provider 152 who got the approval from user 124, notifying that provider 116 is approved by the user 124 to provide a service within an empty table of the user 124. As another non-limiting example, user response may include a rejection. In a non-limiting example, if processor 104 receives rejection of user response for a first general provider, then the processor 104 may determine another general provider 148 as selected provider 152. In another non-limiting example, if processor 104 receives rejection of user response for a first general provider, then the processor 104 may generate and transmit confirm alert to provider device 164 of the first general provider, notifying that the first general provider is rejected by user 124.

With continued reference to FIG. 1, in some embodiments, processor 104 may be configured to generate second timetable 156 using an objective function. In some embodiments, processor 104 may compute a score associated with each provider data 144 and first timetable data 112 and select second timetable 156 to minimize and/or maximize the score, depending on whether an optimal result is represented, respectively, by a minimal and/or maximal score. Objective function may be based on one or more objectives as described below. In various embodiments a score of a particular second timetable 156 may be based on a combination of one or more factors, including provider information 140, provider time information 160, provider preference, provider aversion, time slot, empty table task, empty time information 132, empty table constraint 136, user information, provider quantity, or the like. Each factor may be assigned a score based on predetermined variables. In some embodiments, the assigned scores may be weighted or unweighted.

With continued reference to FIG. 1, in some embodiments, optimization of objective function may include performing a greedy algorithm process. For instance, processor 104 may select second timetable 156 so that scores associated therewith are the best score for each empty table of first timetable.

With continued reference to FIG. 1, in some embodiments, objective function may be formulated as a linear objective function, which processor 104 may solve using a linear program such as without limitation a mixed-integer program. For instance constraint may include provider information 140, provider time information 160, provider preference, provider aversion, time slot, empty table task, empty time information 132, empty table constraint 136, user information, provider quantity, or the like. In various embodiments, system 100 may determine second timetable 156 that maximizes a total score subject to a constraint that includes provider information 140, provider time information 160, provider preference, provider aversion, time slot, empty table task, empty time information 132, empty table constraint 136, user information, provider quantity, or the like. A mathematical solver may be implemented to solve for the set provider information 140, provider time information 160, provider preference, provider aversion, time slot, empty table task, empty time information 132, empty table constraint 136, user information, provider quantity, or the like that maximizes scores; mathematical solver may be implemented on processor 104 and/or another device in apparatus 100, and/or may be implemented on third-party solver.

With continued reference to FIG. 1, in some embodiments, optimizing objective function may include minimizing a loss function. As a non-limiting example, processor 104 may assign variables relating to a set of parameters, which may correspond to score components as described above, calculate an output of mathematical expression using the variables, and select second timetable 156 that produces an output having the lowest size, according to a given definition of “size,” of the set of outputs representing each of plurality of candidate ingredient combinations; size may, for instance, included absolute value, numerical size, or the like. Selection of different loss functions may result in identification of different potential pairings as generating minimal outputs.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm that will be performed by a computing device/module to produce outputs 208 given data provided as inputs 212; this is in contrast to a non-machine learning software program where the commands to be executed are determined in advance by a user and written in a programming language.

With continued reference to FIG. 2, training data 204 may include a plurality of data entries, each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and with continued reference to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure.

With continued reference to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 200 may generate a classifier using a classification algorithm, defined as a process whereby a computing device and/or any module and/or component operating thereon derives a classifier from training data 204. Classification may be performed using, without limitation, linear classifiers such as without limitation logistic regression and/or Ie Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a mathematical and/or algorithmic representation of a relationship between inputs and outputs, as generated using any machine-learning process including without limitation any process as described above and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network including an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

With continued reference to FIG. 2, machine-learning algorithms may include at least a supervised machine-learning process 228. At least a supervised machine-learning process 228, as defined herein, include algorithms that receive a training set relating several inputs to outputs, and seek to find one or more mathematical relations relating inputs to outputs, where each of the one or more mathematical relations is optimal according to some criterion specified to the algorithm using some scoring function. For instance, a supervised learning algorithm may include inputs and outputs described through this disclosure, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With continued reference to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

With continued reference to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of one divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

With continued reference to FIG. 2, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

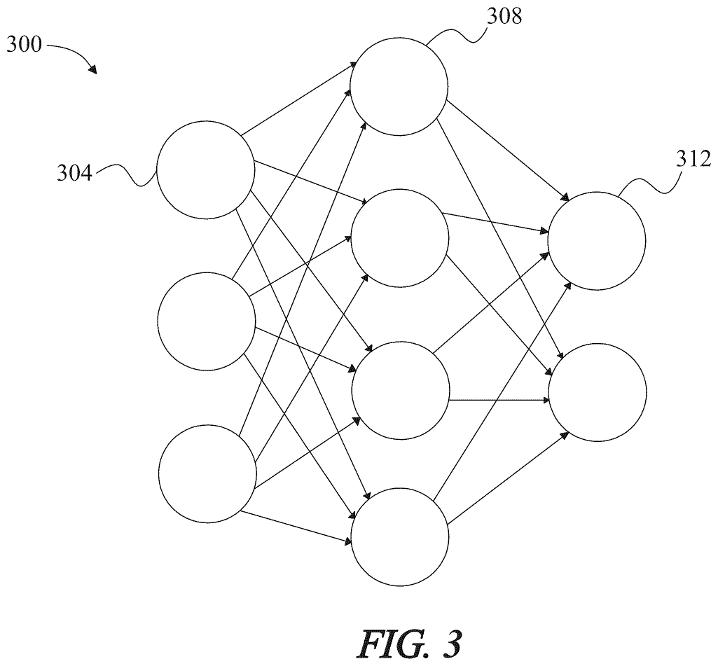

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.”

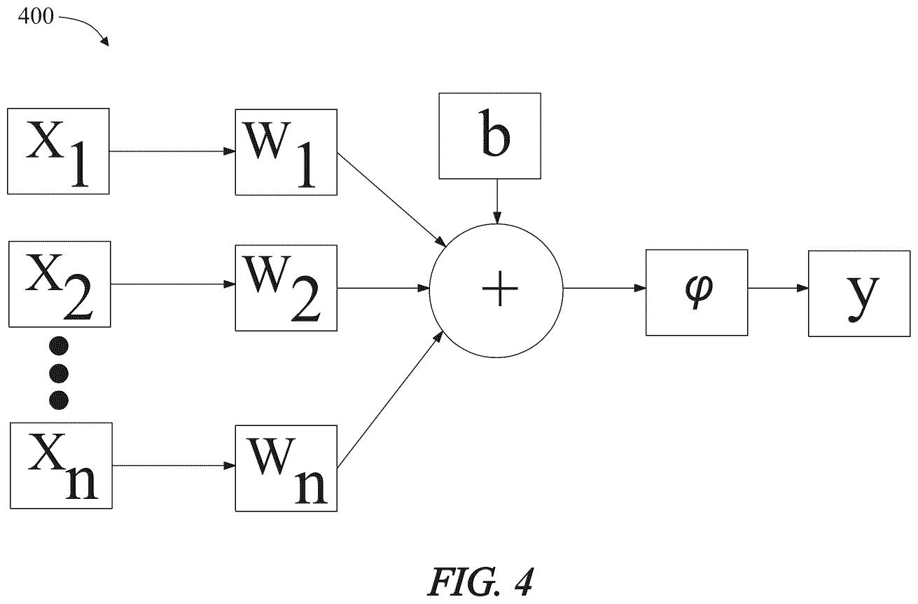

Referring now to FIG. 4, an exemplary embodiment of a node of a neural network is illustrated. A node may include, without limitation, a plurality of inputs xᵢ that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Referring now to FIG. 5, a block diagram of an exemplary timetable database 120 is illustrated. Timetable database 120 is further described in detail with respect to FIG. 1. In some embodiments, timetable database 120 may include first timetable data 112 and any data related to first timetable data 112. As a non-limiting example, timetable database 120 may include first timetable, time slot, slot information, empty table information 128, empty table task, empty table keyword, user information, empty time information 132, empty table constraint 136, constraint keyword, empty table constraint group, constraint weight, constraint keyword, provider quantity. As another non-limiting example, timetable database 120 may include any data derived from user device 156, timetable API, web crawler, or the like.

With continued reference to FIG. 5, in some embodiments, timetable database 120 may include provider data 144 and any data related to provider data 144. As a non-limiting example, timetable database 120 may include provider information 140, provider time information 160, provider preference, preference threshold, provider aversion, or the like. As another non-limiting example, timetable database 120 may include any data derived from provider device 164, timetable API, web crawler, or the like.

With continued reference to FIG. 5, in some embodiments, timetable database 120 may include general provider 148 and any data related to general provider 148. As a non-limiting example, timetable database 120 may include general provider training data, any iterations of determining general provider 148, or the like.

With continued reference to FIG. 5, in some embodiments, timetable database 120 may include selected provider 152 and any data related to selected provider 152. As a non-limiting example, timetable database 120 may include selected provider training data, any iterations of determining selected provider 152, or the like.

With continued reference to FIG. 5, in some embodiments, timetable database 120 may include second timetable 156 and any data related to second timetable 156. As a non-limiting example, timetable database 120 may include confirm feature input 168, provider response, user response, confirm alert, or the like. As another non-limiting example, timetable database 120 may include any iterations of generating second timetable 156, or the like.

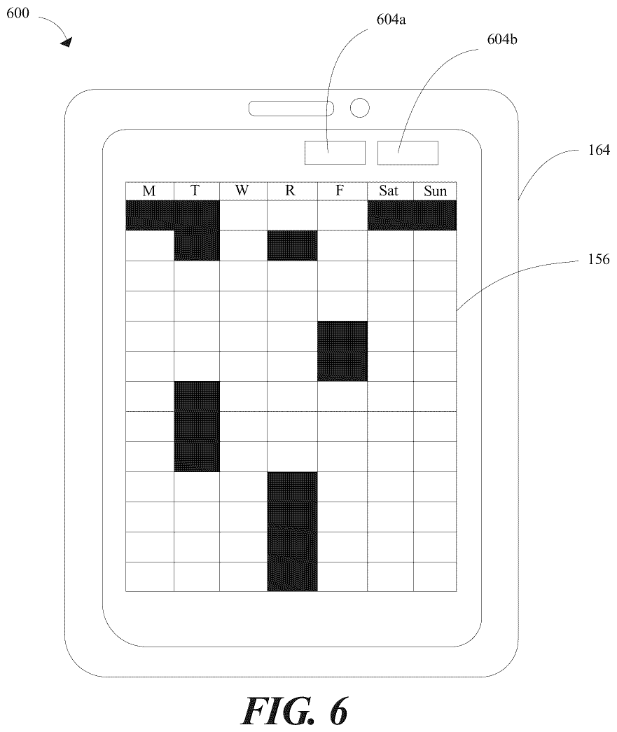

Referring now to FIG. 6, an exemplary embodiment of graphical user interface (GUI) 600 of provider device 164 is illustrated. In FIG. 6, illustrated GUI 600 is merely an example and persons skilled in the art, upon reviewing the entirety of this disclosure, may appreciate various ways to display data using GUI 600. GUI 600 and provider device 164 disclosed herein are described in detail with respect to FIG. 1. In some embodiments, provider device 164 may include a smartphone, tablet, laptop, desktop, smartwatch, or the like. In some embodiments, processor 104 may transmit data to provider device 164. In some embodiments, processor 104 may generate GUI 600 to display the transmitted data. As a non-limiting example, transmitted data may include first timetable data 112, empty table information 128, empty time information 132, empty table task, empty table constraint 136, provider data 144, selected provider 152, second timetable 156, and/or the like. In some embodiments, GUI 600 may display information using text, image, graph, video, table, list, or the like. In some embodiments, provider 116 may interact with GUI 600 using provider device 164. As a non-limiting example, provider 116 may touch a touch screen of provider device 164, click, type, drag, or the like to interact with GUI 600. In some embodiments, GUI 600 may include a confirm feature input button 604a-b. For the purposes of this disclosure, a “confirm feature input button” is a button a provider manipulates to input confirm feature input 168. In some embodiments, provider 116 may input confirm feature input 168 using confirm feature input button 604a-b. As a non-limiting example, provider 116 may click feature input button 604a input confirm feature input 168 of ‘automatically generating a second table 156.’ As another non-limiting example, provider 116 may click feature input button 604b to input confirm feature input 168 of ‘generating a second table 156 as a function of a provider response.’

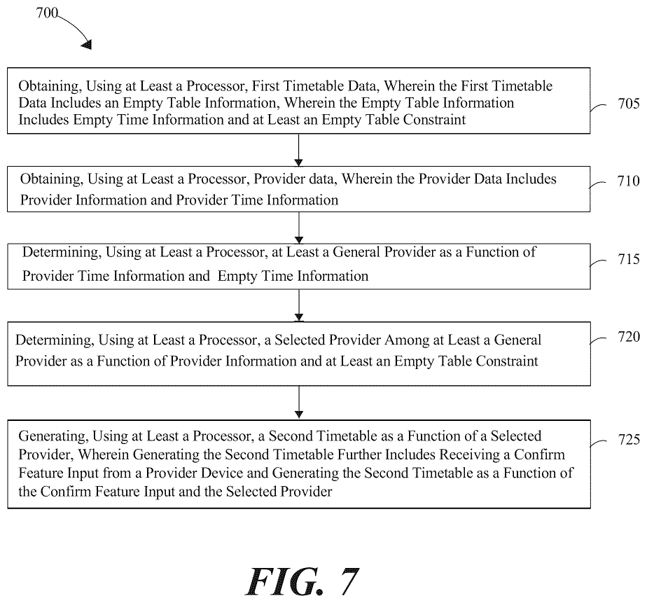

Referring now to FIG. 7, a flow diagram of an exemplary method 700 for generating a timetable. Method 700 includes a step 705 of obtaining, using the at least a processor, first timetable data, wherein the first timetable data includes an empty table information, wherein the empty table information includes empty time information and at least an empty table constraint. In some embodiments, method 700 may further include classifying, using the at least a processor, the empty table constraint into one or more constraint groups. In some embodiments, method 700 may further include determining, using the at least a processor, the selected provider as a function of a constraint weight of the one or more constraint groups. These may be implemented as disclosed with respect to FIGS. 1-6.

With continued reference to FIG. 7, method 700 includes a step 710 of obtaining, using at least a processor, provider data, wherein the provider data includes provider information and provider time information. In some embodiments, the provider data may further include a provider preference, wherein the provider preference comprises a preference threshold. These may be implemented as disclosed with respect to FIGS. 1-6.

With continued reference to FIG. 7, method 700 includes a step 715 of determining, using at least a processor, at least a general provider as a function of provider time information and empty time information. These may be implemented as disclosed with respect to FIGS. 1-6.

With continued reference to FIG. 7, method 700 includes a step 720 of determining, using at least a processor, a selected provider among at least a general provider as a function of provider information and at least an empty table constraint. These may be implemented as disclosed with respect to FIGS. 1-6.

With continued reference to FIG. 7, method 700 includes a step 725 of generating, using at least a processor, a second timetable as a function of a selected provider, wherein generating the second timetable further includes receiving a confirm feature input from a provider device and generating the second timetable as a function of the confirm feature input and the selected provider. In some embodiments, method 700 may further include determining, using the at least a processor, the selected provider as a function of the preference threshold of the provider preference. In some embodiments, method 700 may further include identifying, using the at least a processor, an empty table keyword of the empty table information and determining, using the at least a processor, the selected provider as a function of the empty table keyword and the provider preference. In some embodiments, method 700 may further include identifying, using the at least a processor, a provider keyword of the provider information using a language processing module, identifying, using the at least a processor, a constraint keyword of the empty table constraint using the language processing module and determining, using the at least a processor, the selected provider as a function of the provider keyword and the constraint keyword. In some embodiments, the confirm feature input may include an automatically generating the second timetable input. In some embodiments, the confirm feature input may further include a generating the second timetable as a function of a provider response input. In some embodiments, method 700 may further include generating, using the at least a processor, a confirm alert as a function of the confirm feature input. These may be implemented as disclosed with respect to FIGS. 1-6.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

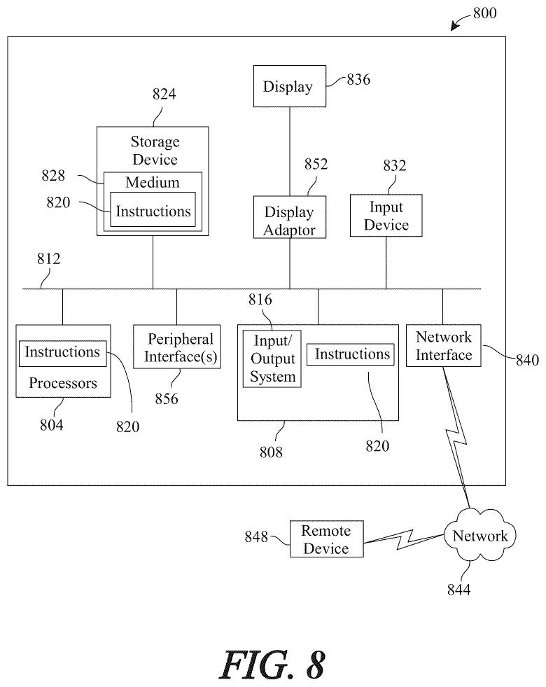

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods and apparatuses according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for generating a timetable, the apparatus comprising:
at least a processor; and
a memory communicatively connected to the at least a processor, wherein the memory contains instructions configuring the at least a processor to:
obtain first timetable data, wherein the first timetable data comprises empty table information, wherein the empty table information comprises empty time information and at least an empty table constraint including a specific skill level;
obtain provider data, wherein the provider data comprises provider information and provider time information and is classified into at least one provider group using a provider group classifier comprising:
receiving provider group training data, wherein the constraint group training data correlates a plurality of provider group data of a first provider and provider preference data to a plurality of provider groups;
training, iteratively, the provider group classifier using the provider group training data, wherein training the provider group classifier includes retraining the provider group classifier with feedback from previous iterations of the provider group classifier; and
classifying the provider data to the provider groups using the trained provider group classifier; and
determine at least a general provider as a function of the provider time information of the provider data, the provider group and the empty time information of the empty table information of the first timetable data;
determine a selected provider among the at least a general provider as a function of the provider information of the provider data and the at least an empty table constraint of the empty table information of the first timetable data, wherein the at least an empty table constraint is classified into one or more constraint groups, wherein the one or more constraint groups comprise a constraint weight, wherein the constraint weight is a predetermined numerical value that indicates an importance of an empty table constraint in relation to one or more other empty table constraints, wherein the constraint weight are stored and retrieved from a timetable database, and wherein the selected provider is determined as a function of the constraint weight, utilizing a machine-learning model comprising a constraint group classifier generated by a classification algorithm further comprising:
receiving constraint group training data, wherein the constraint group training data correlates a plurality of empty table constraints of at least a skill level to at least a skill level group of a plurality of constraint groups;
training, iteratively, the machine-learning model using the constraint group training data, wherein training the machine-learning model includes retraining the machine-learning model with feedback from previous iterations of the machine-learning model;
classifying the at least an empty table constraint to the one or more constraint groups as a function of the specific skill level of the at least an empty table constraint using the trained machine-learning model; and
comparing a constraint weight of a first general provider to a second constraint weight of at least a second provider, wherein the first general provider and the at least a second provider include provider information that aligns with empty table constraint of a constraint group, wherein the general provider with a higher constraint weight is selected as the selected provider;
generate a second timetable as a function of the selected provider, wherein generating the second timetable further comprises:
receiving a confirm feature input from a provider device of the selected provider;
generating the second timetable as a function of the confirm feature input and the selected provider by the processor;
generating a confirm alert, wherein the confirm alert comprises a notification that the empty table information of the first timetable is filled with the selected provider and includes a reminder which prompts the provider to input a provider response; and
transmitting the confirm alert to the provider device of the selected provider.

2. The apparatus of claim 1, wherein the provider data further comprises a provider preference, wherein the provider preference comprises a preference threshold.

3. The apparatus of claim 2, wherein the memory contains the instructions further configuring the at least a processor to determine the selected provider as a function of the preference threshold of the provider preference.

4. The apparatus of claim 2, wherein the memory contains the instructions further configuring the at least a processor to:
identify an empty table keyword of the empty table information; and
determine the selected provider as a function of the empty table keyword and the provider preference.

5. (canceled)

6. (canceled)

7. The apparatus of claim 1, wherein the memory contains the instructions further configuring the at least a processor to:
identify a provider keyword of the provider information using a language processing module;
identify a constraint keyword of the empty table constraint using the language processing module; and
determine the selected provider as a function of the provider keyword and the constraint keyword.

8. The apparatus of claim 1, wherein the provider data comprises a resume of a provider.

9. The apparatus of claim 1, wherein the memory contains instructions further configuring the processor to generate the second timetable as a function of a provider response input.

10. (canceled)

11. A method for generating a timetable, the method comprising:
obtaining, using at least a processor, first timetable data, wherein the first timetable data comprises an empty table information, wherein the empty table information comprises empty time information and at least an empty table constraint including a specific skill level;
obtaining, using the at least a processor, provider data, wherein the provider data comprises provider information and provider time information and is classified into at least one provider group using a provider group classifier comprising:
receiving provider group training data, wherein the constraint group training data correlates a plurality of provider group data of a first provider and provider preference data to a plurality of provider groups;
training, iteratively, the provider group classifier using the provider group training data, wherein training the provider group classifier includes retraining the provider group classifier with feedback from previous iterations of the provider group classifier; and
classifying the provider data to the provider groups using the trained provider group classifier; and
determining, using the at least a processor, at least a general provider as a function of the provider time information, the provider group and the empty time information;
determining, using the at least a processor, a selected provider among the at least a general provider as a function of the provider information and the at least an empty table constraint, wherein the at least an empty table constraint is classified into one or more constraint groups, wherein the one or more constraint groups comprise a constraint weight and the selected provider is determined as a function of the constraint weight, wherein the constraint weight is a predetermined numerical value that indicates an importance of an empty table constraint in relation to one or more other empty table constraints, wherein the constraint weight are stored and retrieved from a timetable database, and utilizing a machine-learning model comprising a constraint group classifier generated by a classification algorithm further comprising:
receiving constraint group training data, wherein the constraint group training data correlates a plurality of empty table constraints of at least a skill level to at least a skill level group of a plurality of constraint groups;
training, iteratively, the machine-learning model using the constraint group training data, wherein training the machine-learning model includes retraining the machine-learning model with feedback from previous iterations of the machine-learning model;
classifying the at least an empty table constraint to the one or more constraint groups as a function of the specific skill level of the at least an empty table constraint using the trained machine-learning model; and
comparing a constraint weight of a first general provider to a second constraint weight of at least a second provider, wherein the first general provider and the at least a second provider include provider information that aligns with empty table constraint of a constraint group, wherein the general provider with a higher constraint weight is selected as the selected provider; and
generating, using the at least a processor, a second timetable as a function of the selected provider, wherein generating the second timetable further comprises:
receiving a confirm feature input from a provider device of the selected provider;
generating the second timetable as a function of the confirm feature input and the selected provider;
generating a confirm alert, wherein the confirm alert comprises a notification that the empty table information of the first timetable is filled with the selected provider and includes a reminder which prompts the provider to input a provider response; and
transmitting the confirm alert to the provider device of the selected provider.

12. The method of claim 11, wherein the provider data further comprises a provider preference, wherein the provider preference comprises a preference threshold.

13. The method of claim 12, further comprising:
determining, using the at least a processor, the selected provider as a function of the preference threshold of the provider preference.

14. The method of claim 12, further comprising:
identifying, using the at least a processor, an empty table keyword of the empty table information; and
determining, using the at least a processor, the selected provider as a function of the empty table keyword and the provider preference.

15. (canceled)

16. (canceled)

17. The method of claim 11, further comprising:
identifying, using the at least a processor, a provider keyword of the provider information using a language processing module;
identifying, using the at least a processor, a constraint keyword of the empty table constraint using the language processing module; and
determining, using the at least a processor, the selected provider as a function of the provider keyword and the constraint keyword.

18. The method of claim 11, wherein the provider data comprises a resume of the provider.

19. The method of claim 11, wherein generating the second timetable comprises generating the second timetable as a function of a provider response input.

20. (canceled)
